(19) United States
(12) Patent Application Publication
(10) Pub. No.: US 2014/0351879 A1
(43) Pub. Date: Nov. 27, 2014

(54) ELECTRONIC APPARATUS, CONTROL METHOD AND STORAGE MEDIUM

(71) Applicant: Kabushiki Kaisha Toshiba, Tokyo (JP)

(72) Inventors: Jun Ohashi, Ome-shi (JP); Tetsuo Hatakeyama, Tachikawa-shi (JP); Tatsuo Yamaguchi, Kunitachi-shi (JP)

(73) Assignee: KABUSHIKI KAISHA TOSHIBA, Tokyo (JP)

(21) Appl. No.: 14/107,763

(22) Filed: Dec. 16, 2013

(30) Foreign Application Priority Data
May 22, 2013 (JP) 2013-107838

(51) Int. Cl. H04L 29/06

(52) U.S. Cl. CPC H04L 63/20
USPC 726/1

(57) ABSTRACT

According to one embodiment, an electronic apparatus includes a multiuser function. The apparatus includes a manager and controller. The manager is configured to provide an environment for restricting a process executable by the apparatus. The controller is configured to detect a request to execute the process, and to transmit contents related to the request to the manager prior to the execution of the process. The manager is configured to transmit a determination result to the controller based on a policy applied to each user and indicative of permission or prohibition of the execution of the process.

### CROSS-REFERENCE TO RELATED APPLICATIONS

This application is based upon and claims the benefit of priority from Japanese Patent Application No. 2013-107838, filed May 22, 2013, the entire contents of which are incorporated herein by reference.

### FIELD

Embodiments described herein relate generally to a policy control technique for an electronic apparatus including a multiuser function.

### BACKGROUND

In recent years, bring-your-own-device (BYOD) computing, where company employees use their own electronic devices in the workplace, has become an attractive proposition for company management. Typical BYOD devices are tablet computers and smartphones.

To realize BYOD, the devices used must be amenable to various security measures.

Many recent devices include a multiuser function, which allows several different users to share a single device in an environment unique to each user. In addition, a single user can use the device in different environments depending on the situation. Therefore, this multiuser function can be employed to support BYOD by separately defining an environment where a management policy is applied (function restriction) for workplace use and an environment where the policy is not applied.

However, in a device including a multiuser function, processes (programs) initiated by more than one user are able to run concurrently, and thus, it has been difficult to flexibly restrict functions. For example, it has been hard to change a policy to be applied depending on each user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing a structure of the electronic apparatus according to the embodiments.

FIG. 2 is an exemplary block diagram showing structures of an access detector and controller and an application executor which are provided within the electronic apparatus according to the embodiments.

FIG. 3 is an exemplary block diagram showing a structure of a management application module within the electronic apparatus according to the embodiments.

FIG. 4 is an exemplary block diagram showing a structure of a determination application module within the electronic apparatus according to the embodiments.

FIG. 5 is an exemplary block diagram showing a structural example of hardware of the electronic apparatus of the embodiments.

FIG. 6 is an exemplary timing chart for explaining an outline of a process for determining permission or prohibition of an event, which is executed by the electronic apparatus of the embodiments when the event occurs.

FIG. 7 is an exemplary flowchart showing procedures of an event process executed by the electronic apparatus of the embodiments when an event occurs.

### DETAILED DESCRIPTION

Various embodiments will be described hereinafter with reference to the accompanying drawings.

In general, according to one embodiment, an electronic apparatus includes a multiuser function. The apparatus includes a manager and controller. The manager is configured to provide an environment for restricting a process executable by the apparatus. The controller is configured to detect a request to execute the process, and to transmit contents related to the request to the manager prior to the execution of the process. The manager is configured to transmit a determination result to the controller based on a policy applied to each user and indicative of permission or prohibition of the execution of the process.

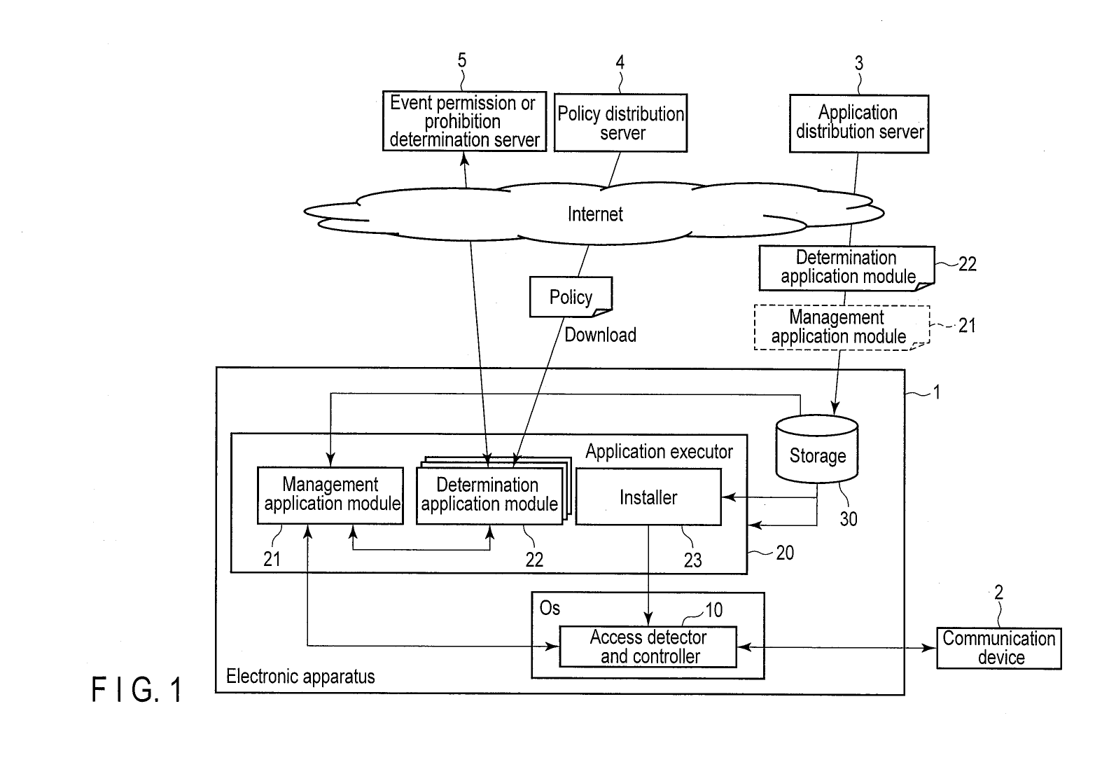

FIG. 1 shows a structure of an electronic apparatus 1 according to one embodiment. The electronic apparatus 1 is configured to execute various application programs, and can be realized by, for example, a tablet computer and a smartphone. The electronic apparatus 1 is configured to access an external storage device such as a USB flash drive and an SD card. The electronic apparatus 1 is configured to wirelessly communicate according to various wireless communication standards such as Wi-Fi (registered trademark), third-generation mobile communications (3G) and Bluetooth (registered trademark). By using this wireless communication function, the electronic apparatus 1 can communicate with an external communication device 2 and various servers on the Internet, etc.

The electronic apparatus 1 includes a process restriction function for restricting various processes such as installation of specific application programs, activation of specific application programs, uninstallation of specific application programs, access between the electronic apparatus 1 and various external communication devices, and access between the electronic apparatus 1 and various external storage devices.

In order to realize the process restriction function, the electronic apparatus 1 includes three different modules which are an access detector and controller 10, a management application module 21, and a determination application module 22.

The access detector and controller 10 can be put into practice by a software module within an operating system (OS) layer. This software module may be middleware within the OS layer, or may be a kernel within the OS layer such as a Linux (registered trademark) kernel. Each of the management application module 21 and the determination application module 22 can be realized by an application program executed on an application executor 20. The application program may be, for example, an Android (registered trademark) application program. The management application module 21 restricts various processes executable by the electronic apparatus 1 in cooperation with the determination application module 22.

The application executor 20 is a platform for running various application programs, and can be realized by a virtual machine such as a Java (registered trademark) virtual machine.

The electronic apparatus 1 can download various application programs (various application package files) from an application distribution server 3 via the Internet. Each of the downloaded application programs is stored in a storage 30 within the electronic apparatus 1. The determination application module 22 is also downloaded from the application distribution server 3 and is saved in the storage 30. Each of the management application module 21 and an installer 23 can be also downloaded from the application distribution server 3. The management application module 21 and the installer 23 can be preinstalled in the electronic apparatus 1. In this case, the management application module 21 does not necessarily need to be downloaded. Similarly, the installer 23 does not necessarily have to be downloaded.

The installer 23 expands an application package file of each of the application programs (the management application module 21, the determination application module 22 and other various applications, etc.) downloaded in the storage 30 from the application distribution server 3, and installs the file in the storage 30.

The application executor 20 loads each of the application programs (the management application module 21, the determination application module 22, the installer 23 and other various applications, etc.) from the storage 30, and executes the programs.

The access detector and controller 10 detects the occurrence of an event requesting the execution of a process, and prior to the execution of the process corresponding to the event, transmits the contents of the event to the management application module 21. The access detector and controller 10 receives a determination result indicating permission or prohibition of the execution of the process corresponding to the event from the management application module 21. Based on the determination result, the access detector and controller 10 controls the execution of the process corresponding to the event. If the determination result indicates authorization to execute the process, the access detector and controller 10 executes the process. If the determination result indicates prohibition of the execution of the process, the access detector and controller 10 prohibits the execution of the process.

In the case where installation and uninstallation of application programs are restricted, the access detector and controller 10 operates as follows. The access detector and controller 10 detects an event requesting installation or uninstallation of an application program. Before executing the event; in other words, before installing or uninstalling the program, the access detector and controller 10 notifies the management application module 21 of the application name to be installed or uninstalled. Based on the determination result from the management application module 21, the access detector and controller 10 controls the execution of installation or uninstallation.

For example, if the access detector and controller 10 detects an event requesting installation of an application program, the access detector and controller 10 suspends a process of installing the application program, and transmits contents of the event including the application name of the application program to the management application module 21. The management application module 21 sends back a determination result indicating permission or prohibition of the installation. Based on this determination result, the access detector and controller 10 executes the installation or stops (prohibits) the execution of the installation.

Similarly, if the access detector and controller 10 detects an event requesting uninstallation of an application program, the access detector and controller 10 suspends a process of uninstalling the application program, and transmits contents of the event including the application name of the application program to the management application module 21. The management application module 21 sends back a determination result indicating permission or prohibition of the uninstallation. Based on this determination result, the access detector and controller 10 executes the uninstallation or stops (prohibits) the execution of the uninstallation.

The access detector and controller 10 can detect not only an event requesting installation or uninstallation of an application program, but also various other events. For example, the access detector and controller 10 detects various events such as a request for application program activation, a request for connection with various communication devices (for example, a request for connection to a Wi-Fi [registered trademark] access point, a request for VPN connection, a request for connection to a Bluetooth [registered trademark] device), a request for SD card connection, and a request for flash drive connection. When these events other than installation and uninstallation events are detected, the access detector and controller 10 also transmits event information indicating the nature of the detected event to the management application module 21 before executing a process corresponding to the event. Based on the determination result from the management application module 21, the access detector and controller 10 can control whether or not the event should proceed.

The management application module 21 functions as a management module which provides an environment for restricting processes executable by the electronic apparatus 1. The management application module 21 can request the access detector and controller 10 to notify the management application module 21 of various events when the management application module 21 is activated. Further, after the management application module 21 receives an event (event information showing contents of the event) from the access detector and controller 10, the management application module 21 notifies the determination application module 22 of the received event, and transmits a determination result (for example, a determination result indicating permission or prohibition of a process corresponding to the event) received from the determination application module 22 to the access detector and controller 10.

Moreover, the management application module 21 includes a function of determining whether or not the determination application module 22 is an appropriate determination application by implementing signature verification for the determination application module 22. The signature verification is executed, for example, at the time of installing or activating the determination application module 22. In the signature verification, the management application module 21 obtains an application package file of the determination application module 22 stored in the storage 30. Based on a certificate, etc. included in the application package file, the management application module 21 determines whether or not the determination application module 22 is an appropriate determination application. This signature verification verifies whether or not the creator of the application package file of the determination application module 22 is appropriate, and whether or not the application package file is an appropriate one which is not falsified.

The determination application module 22 owns a predetermined policy (determination rule). Based on this policy, the determination application module 22 determines permission or prohibition of the event received from the management application module 21, and notifies the management application module 21 of the determination result. The policy may be a white list showing contents of each event to be allowed, or a black list showing contents of each event to be prohibited. The policy may include both of the white list and the black list. The determination application module 22 can download a policy (determination rule) from a policy distribution server 4 depending on the need. By downloading a policy (determination rule) from the policy distribution server 4, a policy can be, for example, regularly and easily updated. A policy may be incorporated in advance into the determination application module 22. Further, the determination application module 22 can query an event permission or prohibition determination server 5 regarding whether or not the event should be executed.

In the present embodiment, the electronic apparatus 1 is assumed to include a multiuser function. Specifically, the OS of the electronic apparatus 1 is supposed to correspond to more than one user. The electronic apparatus 1 of the present embodiment can change, for example, a policy to be applied depending on each user. This technique is explained in detail below.

The above phrase “each user” does not presuppose physically more than one user. The phrase mainly premises logically more than one user as follows. For example, a user logins as a user A when personally using the electronic apparatus 1 at home, etc., and the user logins as a user B when using the electronic apparatus 1 for business at a company, etc. However, the electronic apparatus 1 can be also used by physically more than one user.

The installer 23 instructs the access detector and controller 10 to begin installing or uninstalling an application program based on user operations. In accordance with the instruction from the installer 23, the access detector and controller 10 can detect an installing event or an uninstalling event.

If the determination result reported from the management application module 21 indicates prohibition of installation, the access detector and controller 10 prohibits installation (for example, preparation of a directory (folder) and a file). This prevents an unauthorized application program from being installed. On the other hand, if the determination result reported from the management application module 21 indicates permission of installation, the access detector and controller 10 executes an installing process for installing the application program.

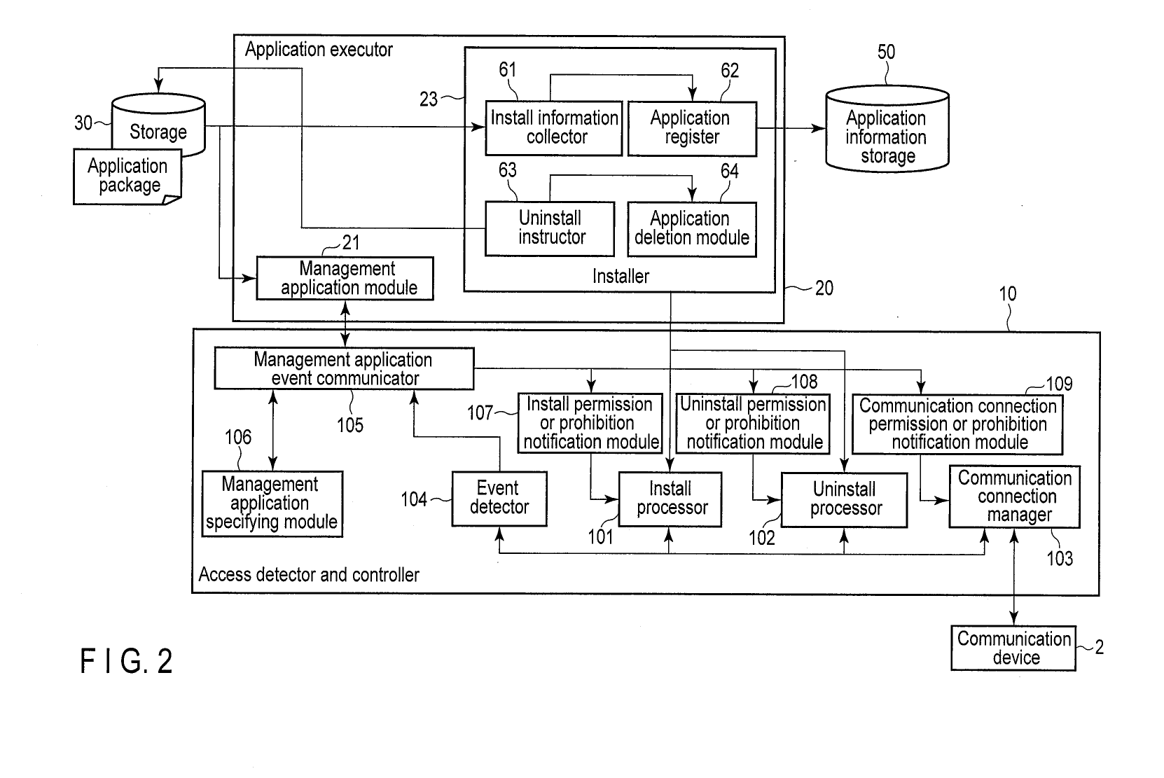

FIG. 2 shows structures of the aforementioned access detector and controller 10 and the application executor 20. It is assumed that the case where install is restricted, uninstall is restricted, and connection with the external communication device 2 is restricted.

As shown in FIG. 2, the instructions of install and uninstall are initiated by the installer 23 (install application). At the time of install, an install information collector 61 of the installer 23 obtains, from the storage 30, an application package file corresponding to the application to be installed. An application register 62 of the installer 23 registers, in an application information storage 50 which is a database where a thumbnail image file, etc. is stored, the application to be installed. The actual installing process such as file preparation is executed by the access detector and controller 10.

An uninstall instructor 63 instructs an application deletion module 64 to uninstall an application in accordance with user operations, and instructs the access detector and controller 10 to initiate uninstall. The application deletion module 64 deletes a thumbnail image file, etc. corresponding to the application to be uninstalled from the application information storage 50.

The access detector and controller 10 includes an install processor 101, an uninstall processor 102, a communication connection manager 103, an event detector 104, a management application event communicator 105, a management application specifying module 106, an install permission or prohibition notification module 107, an uninstall permission or prohibition notification module 108 and a communication connection permission or prohibition notification module 109.

If the install processor 101 receives, from the installer 23, an instruction (install request) to start install, the install processor 101 causes the installer 23 to wait for execution of the installing process. The occurrence of the install request is detected as an install event by the event detector 104. The management application event communicator 105 notifies the management application module 21 of event information (install event information) including the name of the application to be installed.

The management application specifying module 106 specifies which application on the application executor 20 is the management application module 21. After detected in the event detector 104, the event information is transmitted to the application specified as the management application module 21 by the management application specifying module 106 via the management application event communicator 105. Specifically, the management application specifying module 106 holds the application name of the management application module 21 in advance. If the management application specifying module 106 receives a registration request from an application, the management application specifying module 106 determines whether or not the application is the management application module 21 (the application program having the application name held in advance) based on the application name held in advance. Thus, the management application specifying module 106 determines whether or not the application is a communication partner to which the event information should be transmitted. If the application is determined as a communication partner to which the event information should be transmitted, the application is specified as the management application module 21.

The management application event communicator 105 communicates with the application program specified by the management application specifying module 106. This prevents an unauthorized application program from stealing event information.

If a determination result for an install event is received from the management application module 21, the management application event communicator 105 outputs the received determination result to the install permission or prohibition notification module 107. The install permission or prohibition notification module 107 controls operations of the install processor 101 based on the contents of the determination result. If the determination result indicates permission of install, the install processor 101 executes an installing process in cooperation with the installer 23. On the other hand, if the determination result indicates prohibition of install, the install processor 101 suspends the installing process.

If the uninstall processor 102 receives, from the installer 23, an instruction (uninstall request) to initiate uninstall, the uninstall processor 102 causes the installer 23 to wait for the execution of the uninstalling process. The occurrence of the uninstall request is detected as an uninstall event by the event detector 104. The management application event communicator 105 notifies the management application module 21 of event information (uninstall event information) including the name of the application to be uninstalled.

If a determination result indicating permission or prohibition of execution of the uninstall event is received from the management application module 21, the management application event communicator 105 outputs the received determination result to the uninstall permission or prohibition notification module 108. The uninstall permission or prohibition notification module 108 controls operations of the uninstall processor 102 based on the contents of the determination result. If the determination result indicates allowance for uninstall, the uninstall processor 102 executes an uninstalling process in cooperation with the installer 23. On the other hand, if the determination result indicates prohibition of uninstall, the uninstall processor 102 does not implement the uninstalling process. Thus, the execution of the application uninstall requested by a user is prohibited.

The communication connection manager 103 controls connections between the electronic apparatus 1 and the external communication device 2 such as a Wi-Fi (registered trademark) access point, a Bluetooth (registered trademark) device and other network devices. When a connection establishment request is received from the external communication device 2, or a request for transmitting a connection establishment request to the external communication device 2 is generated, the communication connection manager 103 detects the generation of the connection request, and notifies the event detector 104 of the generation of the connection request. The generation of the connection request with the external communication device 2 is detected as a network connection event by the event detector 104. The management application event communicator 105 notifies the management application module 21 of event information (connection event) including information showing an external communication device for the connection.

If a determination result indicating permission or prohibition of execution of a connection event is received from the management application module 21, the management application event communicator 105 outputs the received determination result to the communication connection permission or prohibition notification module 109. The communication connection permission or prohibition notification module 109 controls operations of the communication connection manager 103 based on the contents of the determination result. If the determination result indicates allowance for connection, the communication connection manager 103 executes a process for establishing connection with a communication device to be connected. On the other hand, if the determination result indicates prohibition of connection, the communication connection manager 103 prohibits establishment of connection with the communication device to be connected.

It is also possible to, for example, restrict connection with an external storage device as mentioned above although this structure is not indicated in FIG. 2. For example, when an SD card is inserted, event information showing this insertion is transmitted from the access detector and controller 10 to the management application module 21. A determination result indicating whether or not the connection with the SD card is allowable is sent back to the access detector and controller 10 from the management application module 21.

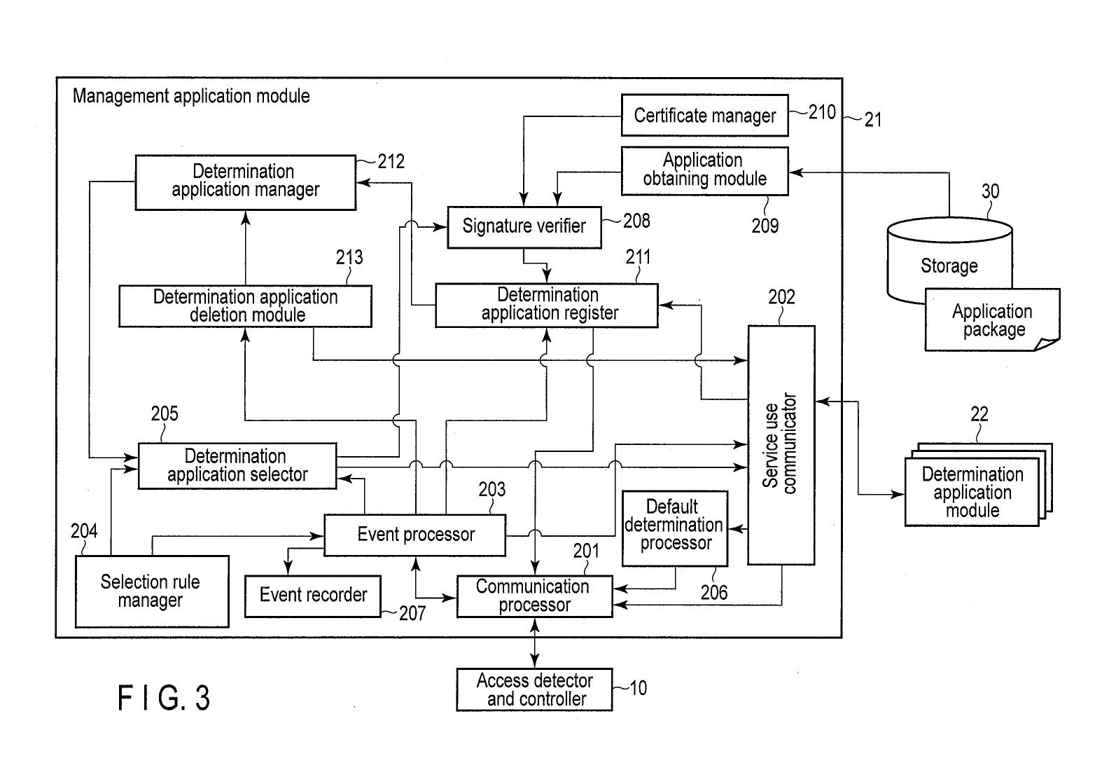

FIG. 3 shows a structure of the management application module 21.

The management application module 21 includes a communication processor 201, a service use communicator 202, an event processor 203, a selection rule manager 204, a determination application selector 205, a default determination processor 206, an event recorder 207, a signature verifier 208, an application obtaining module 209, a certificate manager 210, a determination application register 211, a determination application manager 212 and a determination application deletion module 213.

The communication processor 201 communicates with the access detector and controller 10. The communication processor 201 receives various events (an install event, an event for requesting connections with various communication devices, an event for requesting connection with an SD card, an event for requesting connection with a flash drive, and an uninstall event, etc.) reported from the access detector and controller 10. To the communication between the management application module 21 and the access detection and control module, a method such as a signal system call may be applied.

The service use communicator 202 communicates with the determination application module 22. The event processor 203 transmits the contents of an event to the determination application module 22 via the service use communicator 202, and receives a determination result indicating permission or prohibition of execution of the event from the determination application module 22 via the service use communicator 202.

As described previously, the present embodiment presumes that the electronic apparatus 1 includes a multiuser function. For example, the electronic apparatus 1 of the present embodiment activates a plurality of determination application modules 22 in order to allocate them depending on each user. The event processor 203 adaptively sorts out the determination application modules 22 to which the contents of events should be transmitted. In this manner, a policy to be applied can be changed depending on each user, for example.

Based on the selection rule managed by the selection rule manager 204, the event processor 203 adaptively sorts out the determination application modules 22 to which the contents of events should be transmitted in cooperation with the determination application selector 205. The method for sorting out the determination application modules 22 is explained later.

For example, if no determination application module 22 is installed, there is no determination application module 22 to which the contents of an event should be transmitted. In such a situation, based on the policy at the default state, the default determination processor 206 determines permission or prohibition of execution of the event as a substitute for the determination application module 22.

The event recorder 207 records the contents of the event notified from the access detector and controller 10 as an event log.

As mentioned above, the management application module 21 includes a function of determining whether or not the determination application module 22 is an authorized determination application by executing signature verification for the determination application module 22. The signature verifier 208, the application obtaining module 209 and the certificate manager 210 are responsible for the execution of the signature verification. For example, if validity is verified by signature verification at the time of activation, the determination application module 22 is recorded in the determination application manager 212 by the determination application register 211. In the determination application manager 212, for example, the determination application modules 22 which are equal to users in number are recorded. When the determination application modules 22 end, their records are deleted from the determination application manager 212 by the determination application deletion module 213.

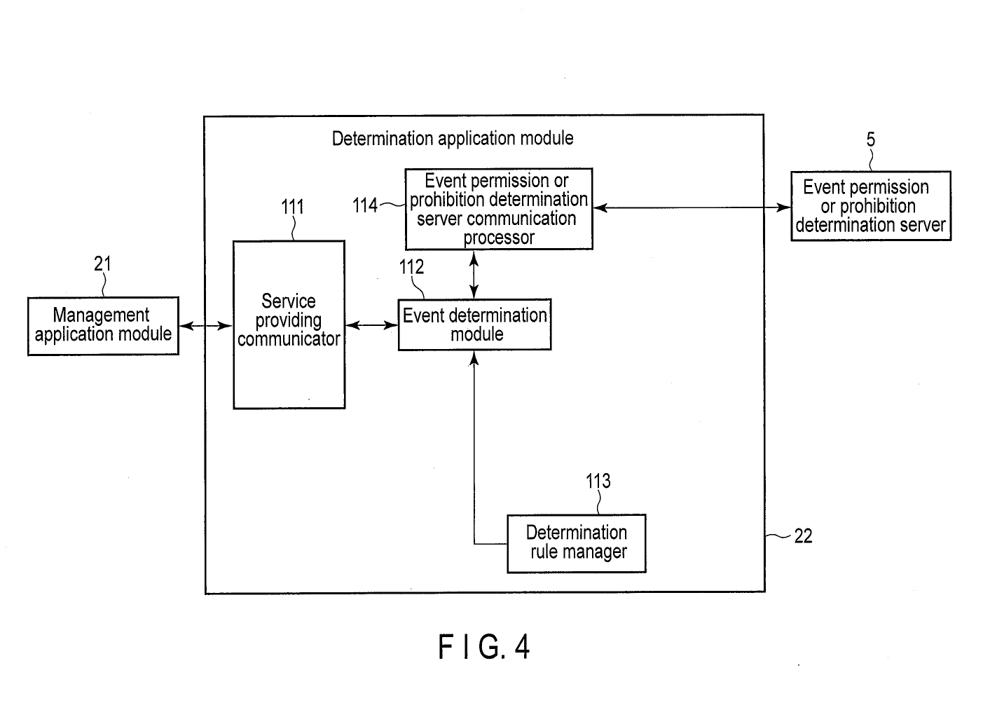

FIG. 4 shows a structure of the determination application module 22. As shown in FIG. 4, the determination application module 22 includes a service providing communicator 111, an event determination module 112, a determination rule manager 113 and an event permission or prohibition determination server communication processor 114.

The service providing communicator 111 communicates with the management application module 21. The event determination module 112 determines permission or prohibition of execution of a process corresponding to each event based on a policy existing within the determination rule manager 113.

The event permission or prohibition determination server communication processor 114 queries the event permission or prohibition determination server 5 regarding whether or not a process corresponding to each event should be executed, and receives permission or prohibition of execution of the process from the event permission or prohibition determination server 5. The event determination module 112 is also configured to determine whether or not the process should be executed by the use of the event permission or prohibition determination server communication processor 114 depending on the need.

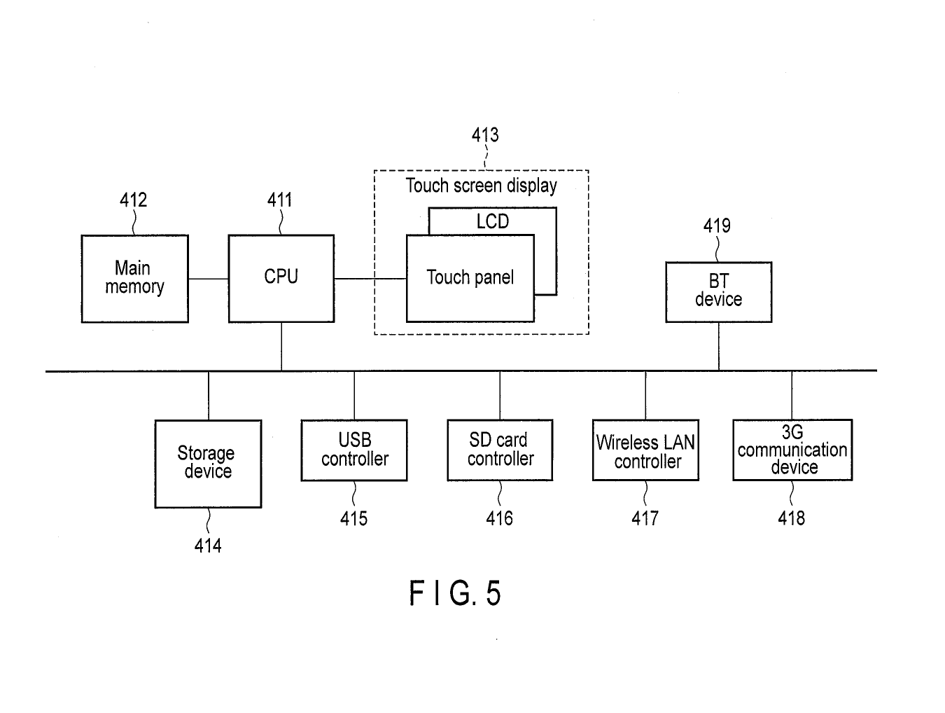

FIG. 5 shows an example of a hardware structure of the electronic apparatus 1. The electronic apparatus 1 includes a CPU 411, a main memory 412, a touchscreen display 413, a storage device 414, a USB controller 415, an SD card controller 416, a wireless LAN controller 417, a 3G communication device 418 and a Bluetooth (registered trademark) device 419, etc.

The CPU 411 is a processor which controls each component within the electronic apparatus 1. The CPU 411 executes various software loaded in the main memory 412 from the storage device 414. For example, an OS and an application program are executed. The aforementioned access detector and controller 10 is executed as a part of the OS.

The management application module 21 and the determination application module 22 are realized as different application programs from each other as mentioned previously. An application program corresponding to the management application module 21 may be preinstalled in the storage device 414 as discussed above.

The touchscreen display 413 is a display configured to detect a touched position on a screen, and includes a flat panel display such as a liquid crystal display device (LCD), and a touchpanel.

The USB controller 415 is configured to communicate with a USB device (for example, a USB memory) attached to a USB port provided in the electronic apparatus 1. The SD card controller 416 is configured to communicate with a memory card (for example, an SD card) inserted into a card slot provided in the electronic apparatus 1. The wireless LAN controller 417 is a wireless communication device configured to wirelessly communicate in conformity to Wi-Fi (registered trademark), etc. The 3G communication device 418 is a wireless communication device configured to execute 3G mobile communications. The Bluetooth (registered trademark) device 419 is a wireless communication device configured to communicate with an external Bluetooth (registered trademark) device.

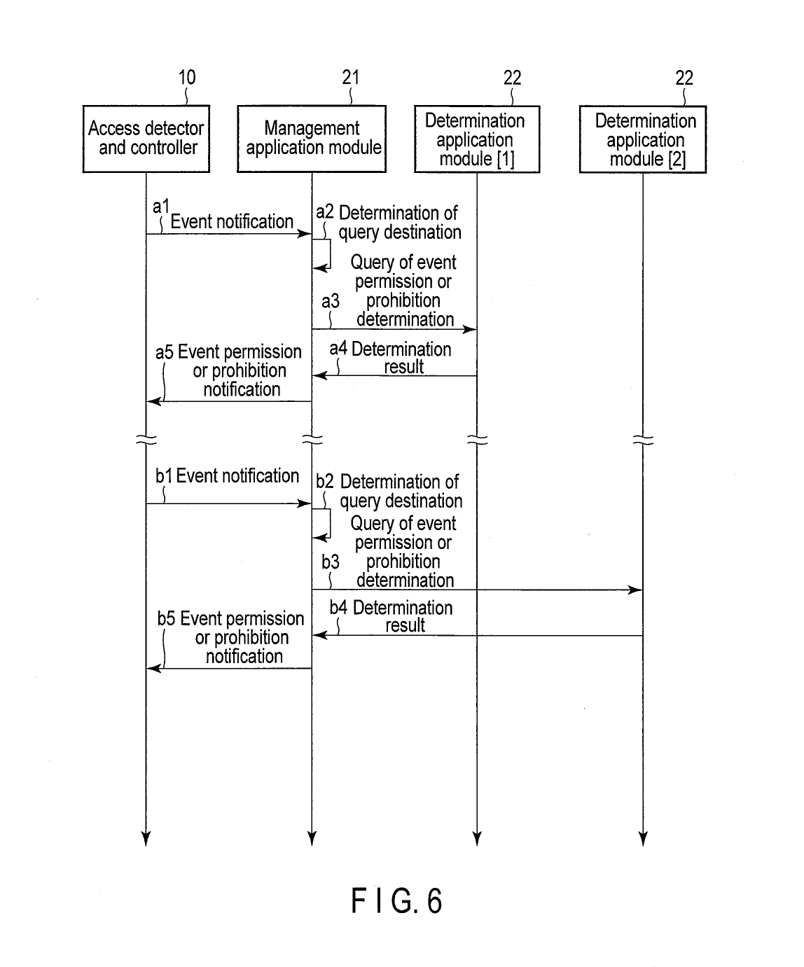

FIG. 6 is an exemplary timing chart for explaining an outline of a process of determining whether or not an event should be implemented, which is executed by the electronic apparatus 1 when the event occurs.

When an event for restricting a function such as a request for installing or uninstalling an application program, a request for activating an application program, a request for accessing an external communication device and a request for accessing an external storage device occurs, the occurrence of the event is detected by the access detector and controller 10. The contents of the event are reported to the management application module 21 (a1 and b1 of FIG. 6).

If the management application module 21 receives an event (event information indicating the contents of an event) from the access detector and controller 10, the determination application module 22 to which the event should be reported is determined (a2 and b2 of FIG. 6). When the determination application module 22 which is the destination of the notification is determined, the management application module 21 notifies the determination application module 22 of the event (a3 and b3 of FIG. 6).

The management application module 21 receives a determination result indicating permission or prohibition of the execution of an event from the determination application module 22 (a4 and b4 of FIG. 6), and notifies the access detector and controller 10 of permission or prohibition indicated by the determination result for the execution of the event (a5 and b5 of FIG. 6).

The determination result for each event may be different depending on the determination application module 22 (by differentiating policies managed by the determination rule manager 113). Therefore, the destination of the notification of an event is adaptively selected to, for example, change the policy to be applied depending on the user.

The management application module 21 could operate at the following three operation modes by the configuration of the selection rule manager 204.

(a) First Operation Mode

The same policy is applied to all users.

(b) Second Operation Mode

The same policy is applied to all users except for the specific users called as, for example, an administrator. Function restrictions are not applied to the specific users.

(c) Third Operation Mode

A different policy is applied depending on each user. At the third operation mode, a policy to be applied can be changed depending on the user. The same policy can be also applied to a plurality of users.

This specification explains operations of the management application module 21 when the first operation mode is set.

A user attribution showing from which user process (program) the request is sent is attached to an event reported from the access detector and controller 10. Based on the user attribution held by the event, the event processor 203 basically determines to which determination application module 22 the event should be reported. In consideration of this basis, when the first operation mode is set, regardless of the user shown by the user attribution, the event processor 203 notifies the determination application module 22 allocated for the specific user (via the service use communicator 202) of the event reported from the access detector and controller 10. In cooperation with the determination application selector 205, the event processor 203 selects one of the determination application modules 22 to report the event. In other words, at the first operation mode, the determination application module 22 to be allocated for the specific user is specified. The determination application selector 205 specifies the determination application module 22 to be allocated for the specific user by reference to the records of the determination application manager 212.

By fixing the notification destination of an event to the determination application module 22 allocated for the specific user, the same policy is applied to all users.

Next, this specification explains operations of the management application module 21 when the second operation mode is set.

When the second operation mode is set, the event processor 203 determines whether or not the user shown by the user attribution held by an event is the specific user. If the user is the specific user, the event processor 203 notifies the access detector and controller 10 of permission of the execution of the event (via the communication processor 201) without notifying the determination application module 22 of the event.

On the other hand, in the case of users other than the specific user, the event processor 203 reports the event to the determination application module 22 allocated to all users other than the specific user in common. For example, the event processor 203 causes the determination application selector 205 to select, as the notification destination of the event, the determination application module 22 for a virtual user. This determination application module 22 is operated for integrating all users except for the specific user.

In the case of the specific user, the permission of the execution of an event is answered without reporting the event to the determination application module 22. Thus, function restrictions are not applied to the specific user. Since the determination application 22 which is the notification destination of the event in the case of users other than the specific user is fixed, the same policy is applied to all users other than the specific user.

This specification now explains operations of the management application module 21 when the third operation mode is set.

When the third operation mode is set, the event processor 203 causes the determination application selector 205 to select, as the notification destination of the event, the determination application module 22 allocated for the user shown by the user attribution held by the event. The event processor 203 informs the determination application selector 205 selected by the determination application selector 205 of the event.

By setting the notification destination of the event as the determination application module 22 allocated for each user, a different policy is applied depending on each user. In a strict sense, a policy to be applied can be different depending on each user (as the same policy could be managed by the determination rule manager 113 at the plurality of determination application modules 22).

As mentioned previously, based on the user attribution held by the event, the event processor 203 basically determines the determination application module 22 to which the event should be reported. However, for example, events such as Wi-Fi (registered trademark) connection and SD card insertion do not have a user attribution.

In the case of the second operation mode or the third operation mode, the event processor 203 could operate as follows for the events which do not have user attributions. An operation to be performed may be determined as a specification or may be appropriately selected by the configuration of the selection rule manager 204.

(a) The event processor 203 reports the event which does not have a user attribution to the determination application module 22 of the specific user (such as an administrator).

(b) The event processor 203 reports the event which does not have a user attribution to the determination application module 22 of a foreground user.

(c) The event processor 203 reports the event which does not have a user attribution to the determination application modules 22 of all users, and determines whether or not the execution should be permitted by majority vote of the determination results.

(d) The event processor 203 reports the event which does not have a user attribution to the determination application modules 22 of all users. If all determination results indicate permission of the execution, the execution is determined as allowable (if one or more determination result indicates prohibition of the execution, the execution is determined to be prohibited).

(e) Without notification to the determination application module 22, permission or prohibition of the execution is determined at the default determination processor 206.

By conducting one of the above operations, permission or prohibition of the execution of an event which does not have a user attribution can be also appropriately determined.

In the case of an electronic apparatus including a multiuser function, processes (programs) of more than one user could concurrently operate. Specifically, a process (program) of a background user could operate in parallel with a process (program) of a foreground user. For example, when a policy which allows an event to be executed is applied to a foreground user, and a policy which prohibits the event from being executed is applied to a background user, the process (program) of the background user could operate at a state where the original policy is not applied, and the execution of the event could be permitted.

In order to prevent such a situation, for example, when the specific user to whom function restrictions are not applied is a foreground user, the process (program) of a background user may be suspended. This can be realized by, for example, causing the access detector and controller 10 to detect and report an event in which the specific user is a foreground user, and causing the event processor 203 to request the access detector and controller 10 executed as a part of the OS to stop the process (program) of the background user.

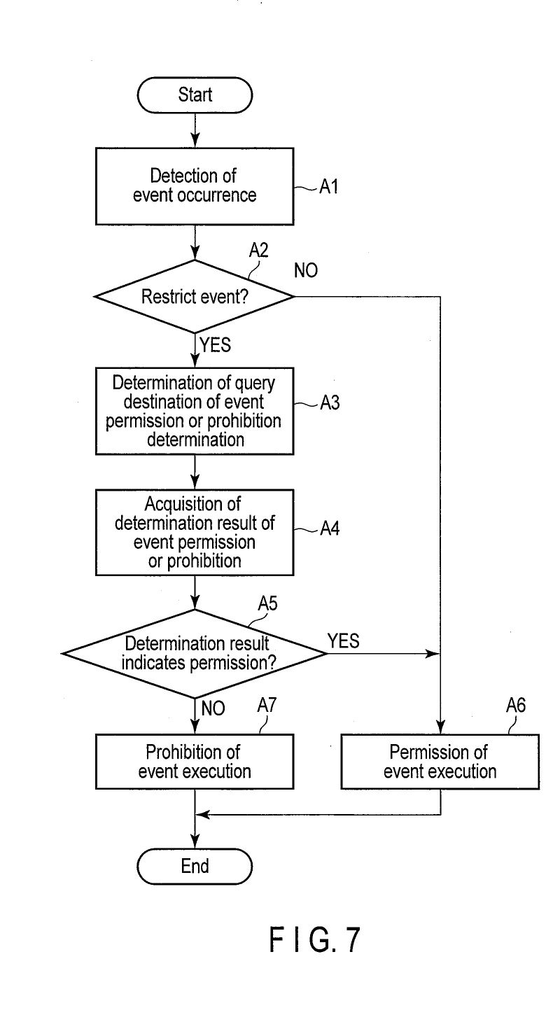

FIG. 7 is an exemplary flowchart showing procedures for processing an event, which are executed by the electronic apparatus 1 at the time of event occurrence.

The access detector and controller 10 detects event occurrence (Block A1), and determines whether or not the event should be restricted (Block A2). If the event should be restricted (YES in Block A2), the access detector and controller 10 notifies the management application module 21 of the event. The management application module 21 received the event notification determines to which determination application 22 the event should be reported (Block A3), and reports the event.

The management application module 21 receives a determination result indicating whether or not the event should be executed from the determination application module 22 (Block A4). If the determination result indicates permission of the execution (YES in Block A5), the permission of the execution of the event is reported to the access detector and controller 10. The access detector and controller 10 received this notification permits the execution of the event (Block A6). Even if the detected event is not an event to be restricted (NO in Block A2), the access detector and controller 10 permits execution of the event (Block A6).

On the other hand, if the determination result received from the determination application module 22 indicates prohibition of the execution (NO in Block A5), the management application module 21 notifies the access detector and controller 10 of the prohibition of the execution of the event. The access detector and controller 10 received this notification prohibits execution of the event (Block A7).

As described above, the electronic apparatus 1 of the present embodiment is configured to flexibly restrict functions. For example, a policy to be applied can be changed depending on each user.

The processing procedures of the present embodiment can be implemented by software. Therefore, by installing a computer program executing these procedures into a normal computer through a computer readable storage medium in which the computer program is stored, the effect which is the same as the present embodiment can be readily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising a multiuser function, the apparatus comprising:
a manager configured to provide an environment for restricting a process executable by the apparatus; and
a controller configured to detect a request to execute the process, and to transmit contents related to the request to the manager prior to the execution of the process,
wherein the manager is configured to transmit a determination result to the controller based on a policy applied to each user and indicative of permission or prohibition of the execution of the process.

2. The apparatus of claim 1, wherein the manager is configured to report the contents related to the request to a determination program corresponding to a user attribution held by the request, and to receive the determination result from the determination program.

3. The apparatus of claim 1, wherein the manager comprises:
a first operation mode configured to report the contents related to the request to a determination program allocated for a specific user, to receive the determination result from the determination program, and to transmit the determination result to the controller;
a second operation mode configured
to transmit, when a user attribution held by the request corresponds to the specific user, the determination result indicative of permission of the execution of the process,
to report, when the user attribution held by the request does not correspond to the specific user, the contents related to the request to a common determination program allocated for all users other than the specific user,
to receive the determination result from the common determination program, and
to transmit the determination result to the controller; and
a third operation mode configured
to report the contents related to the request to the determination program corresponding to the user attribution held by the request,
to receive the determination result from the determination program, and
to transmit the determination result to the controller.

4. The apparatus of claim 3, wherein the manager is configured to report, when the request does not have the user attribution, the contents related to the request to the determination program allocated for the specific user, and to receive the determination result from the determination program.

5. The apparatus of claim 3, wherein the manager is configured to report, when the request does not have the user attribution, the contents related to the request to a first determination program allocated for a foreground, and to receive the determination result from the first determination program.

6. The apparatus of claim 3, wherein the manager is configured to report, when the request does not have the user attribution, the contents related to the request to all of the determination programs, to determine permission or prohibition of the execution of the process by majority vote of the determination results received from the determination programs, and to transmit the determination result indicative of permission or prohibition of the execution of the process to the controller.

7. The apparatus of claim 3, wherein the manager is configured
to report, when the request does not have the user attribution, the contents related to the request to all of the determination programs,
to transmit, when all the determination results received from the determination programs indicate permission of the execution of the process, the determination result indicative of permission of the execution of the process to the controller, and
to transmit, when at least one of the determination results indicates prohibition of the execution of the process, the determination result indicative of prohibition of the execution of the process to the controller.

8. The apparatus of claim 3, wherein the manager is configured to determine, when the request does not have the user attribution, permission or prohibition of the execution of the process based on a policy applied in common for all the users, and to transmit the determination result indicative of permission or prohibition of the execution of the process to the controller.

9. The apparatus of claim 1, wherein the manager is configured to suspend a program of a background user when a first user to whom the restriction of the process executable in the apparatus is unapplied is a foreground user.

10. A control method for restricting a process executable in an electronic apparatus comprising a multiuser function, the method comprising:
detecting a request to execute a process;
determining a response to the request indicative of permission or prohibition of the execution of the process based on a policy applied for each user; and
executing the process when the response indicates permission for the execution of the process.

11. A computer-readable, non-transitory storage medium having stored thereon a computer program which is executable by a computer which comprises a multiuser function, the computer program controlling the computer to function as:
a manager configured to provide an environment for restricting a process executable by the computer; and
a controller configured to detect a request to execute the process, and to transmit contents related to the request to the manager prior to the execution of the process,
wherein the manager is configured to transmit a determination result of the request to the controller based on a policy applied for each user, indicative of permission or prohibition of the execution of the process.
